(19) United States
(12) Patent Application Publication
(10) Pub. No.: US 2011/0107555 A1
(43) Pub. Date: May 12, 2011

(54) HINGE

(75) Inventors: Chad M. Buchanan, Mequon, WI (US); Matthew J. Alles, West Bend, WI (US)

(73) Assignee: Hessco, Inc.

(21) Appl. No.: 12/729,625

(22) Filed: Mar. 23, 2010

Related U.S. Application Data
(60) Provisional application No. 61/162,640, filed on Mar. 23, 2009.

(51) Int. Cl. E05D 7/06; E05D 7/04

(52) U.S. Cl. 16/237; 16/242; 16/243; 16/239

(57) ABSTRACT

A hinge comprises a first leaf, a first plate, at least one sleeve coupled to the first plate, a second leaf having a second plate and an adjustment mechanism. The adjustment mechanism is configured to move and retain one of the first leaf and the second leaf relative to the other of the first leaf and the second leaf at a plurality of positions in a first direction substantially perpendicular to the axis while the second plate extends substantially parallel to the first plate and while the first plate and the second plate are mounted to structures being pivoted by the hinge.

### CROSS-REFERENCE TO RELATED PATENT APPLICATIONS

The present application claims priority under 35 U.S.C. 119(e) from co-pending U.S. Provisional Application Ser. No. 61/162,640 filed on Mar. 23, 2009 by Chad M. Buchanan and Matthew J. Alles and entitled HINGE, the full disclosure of which is hereby incorporated by reference.

### BACKGROUND

Hinges are sometimes used to pivotally support a door in a frame. Squaring and positioning the door in the frame may be difficult. Existing adjustable hinges facilitate such positioning, but are complex, bulky, unattractive, difficult to use and may require special modifications to the frame and/or the door to accommodate such hinges.

### BRIEF DESCRIPTION OF THE DRAWINGS

FIG. 1 is a front perspective view of a hinge according to an example embodiment.

FIG. 2 is a left side perspective view of the hinge of FIG. 1.

FIG. 3 is another perspective view of the hinge of FIG. 1.

FIG. 4 is a top perspective view of the hinge of FIG. 1.

FIG. 5 is an exploded perspective view of an adjustment mechanism of the hinge of FIG. 1.

FIG. 6 is an exploded perspective view of a cam, guide and retainer mechanism of the hinge of FIG. 1.

FIG. 7 is a sectional view of the hinge of FIG. 1 in a first state.

FIG. 8 is a sectional view of the hinge of FIG. 1 in a second state.

FIG. 9 is a sectional view of the hinge of FIG. 1 with a leaf plate in a first position.

FIG. 10 is a sectional view of the hinge of FIG. 1 with the leaf plate in a second position.

FIG. 11 is a sectional view of the hinge of FIG. 1 with the leaf plate in a third position.

FIG. 12 is a sectional view of the hinge of FIG. 1.

FIG. 13 in a perspective view of another embodiment of a retainer mechanism of the hinge of FIG. 1.

FIG. 14 is a sectional view of another embodiment of the hinge of FIG. 1

FIG. 15 is a fragmentary front perspective view of the hinge of FIG. 14.

FIG. 16 is a fragmentary front perspective view of the end of FIG. 14 with a cap removed.

FIG. 17 is a front perspective view of the hinge of FIG. 14.

### DETAILED DESCRIPTION OF THE EXAMPLE EMBODIMENTS

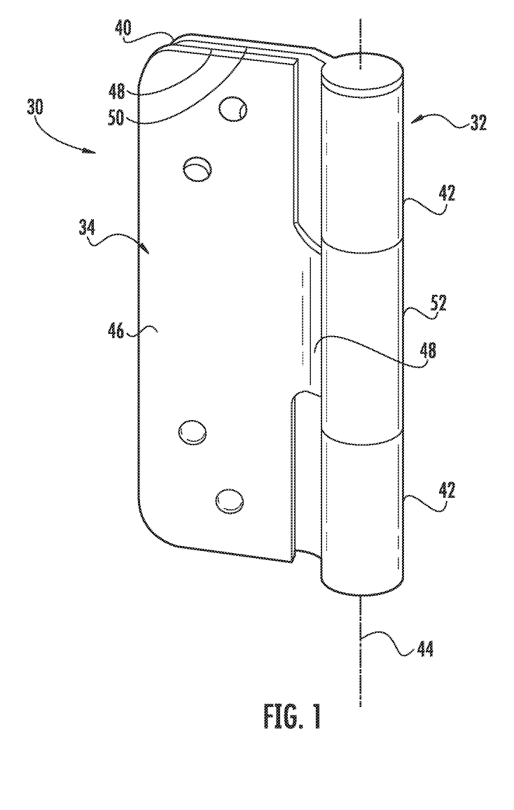

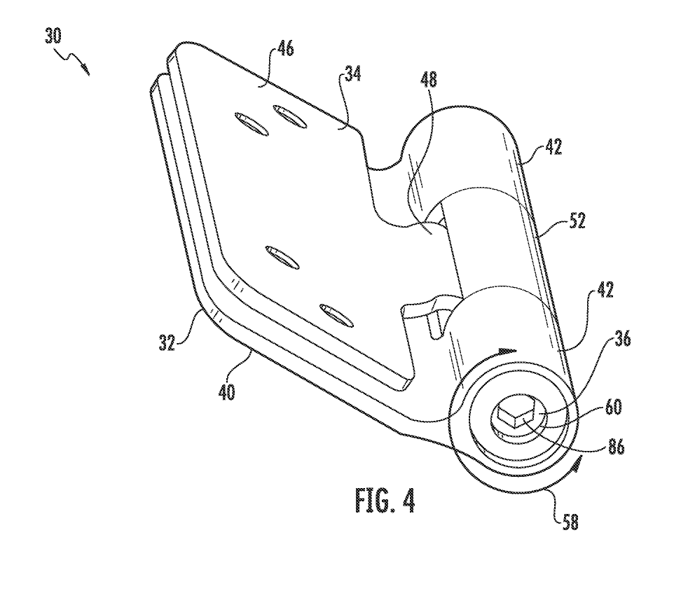

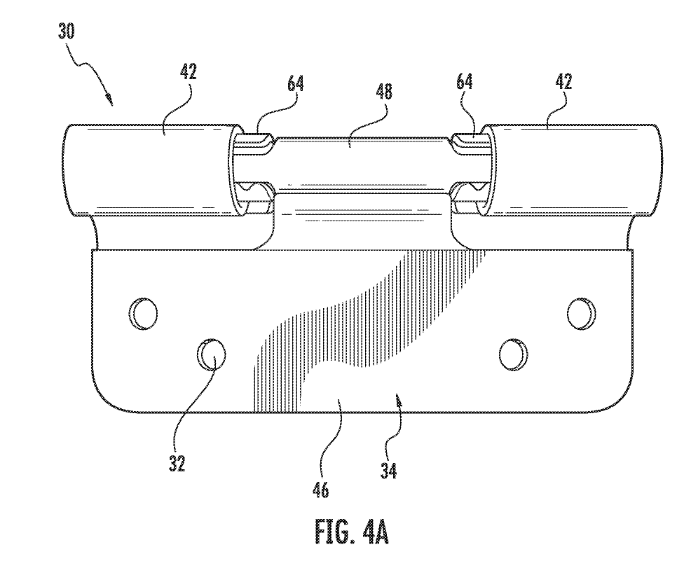

FIGS. 1-4A illustrates a hinge 30 according to an example embodiment. Hinge 30 is configured to secure any two parts that need to be rotated relative to each other such as a door within a frame. FIG. 4A illustrates hinge 30 omitting a cover 52. As will be described hereafter, hinge 30 is configured to facilitate adjustable positioning of the door in a generally horizontal direction in a compact and aesthetically attractive form factor or package. Hinge 30 generally includes frame leaf 32, door leaf 34 and adjustment mechanism 36 (shown in FIG. 4). Frame leaf 32 includes a frame plate 40 and sleeves 42. Frame plate 40 is configured to bear against or abut a wall or a frame. Sleeves 42 extend from frame plate 40 and extend along or are centered along an axis 44. Although frame leaf 40 is illustrated as including a pair of sleeves 42, in other embodiments, frame leaf 40 may have a greater or fewer of such sleeves. Sleeves 42 form a barrel providing axis 44 about which door leaf 34 rotates or pivots. Although sleeves 42 are illustrated as being integrally formed as a single unitary body with plate 40, in other embodiments, sleeves 42 may be separate parts joined or connected to plate 40.

Door leaf 34 includes door plate 46 and stem 48. Door plate 46 is configured to abut and bear against the edge of the door to be hung using hinge 30. When the door being hung is closed (fit within the frame), door plate 46 and frame plate 40 have opposing faces 48, 50 that extend substantially parallel to one another and that extend in a close proximity with one another or contact and abut one another as in the positions shown in FIG. 1. As a result, when the door is in the closed position, both frame plate 40 and/or plate 46 are sandwiched between the edge of the door and the edge of the frame, being largely inaccessible.

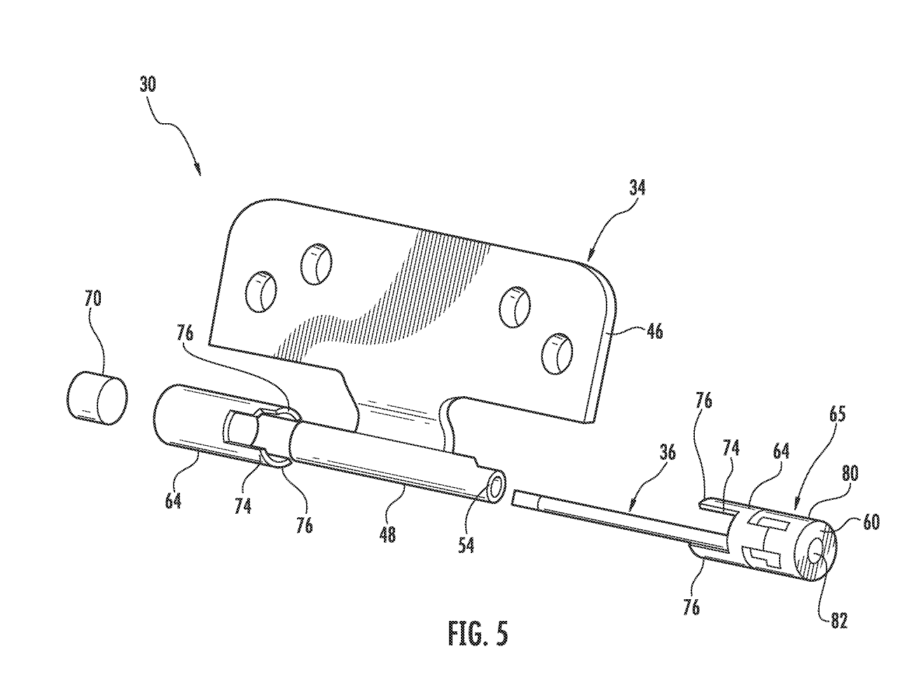

Stem 48 comprises a projection that extends from door plate 46 into operable engagement or coupling with adjustment mechanism 36. In the example illustrated, stem 48 extends to a location between sleeves 42. In the example illustrated, the connection between stem 48 and adjustment mechanism 36 is shielded or concealed by shroud or cover 52. As shown in more detail in FIG. 5, stem 48 of door leaf 34 includes an elongate slot, opening or channel 54. As will be described hereafter, channel 54 facilitates coupling of door leaf 34 to adjustment mechanism 36. Although channel 54 is illustrated as open or U-shaped, in some embodiments, channel 56 may be closed, being ovular or elliptical in shape.

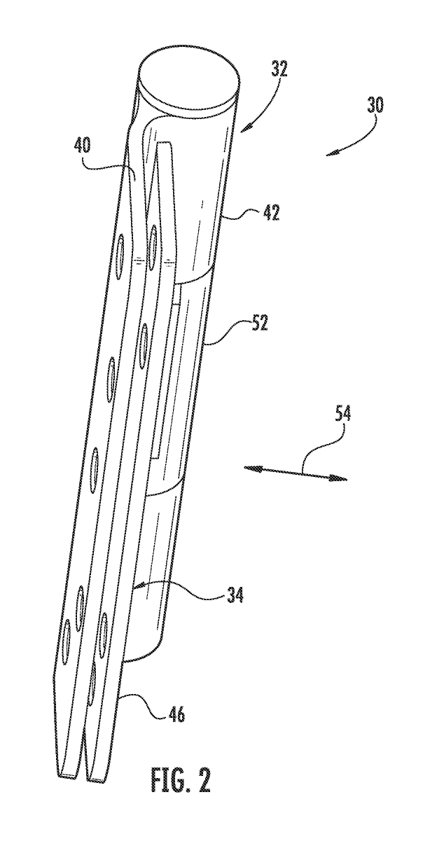

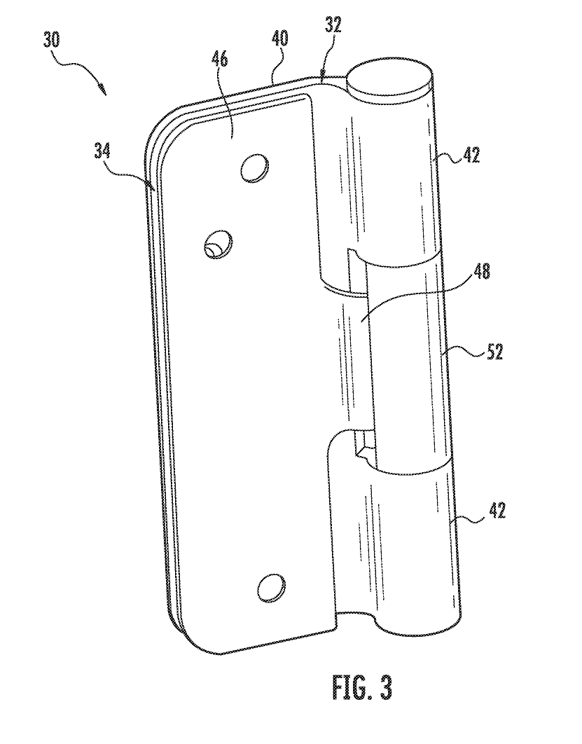

Adjustment mechanism 36 facilitates extension of horizontal adjustment or repositioning of door leaf 34 relative to frame leaf 32. Adjustment mechanism 36 facilitates movement of door leaf 34 in a direction substantially perpendicular to axis 44 (into and out of the page in FIG. 1) or in the direction largely indicated by arrows 56 in FIG. 2. Adjustment mechanism 36 is configured to move and retain door leaf 34 relative to frame leaf 32 at a plurality of positions while door plate 46 is connected to a closed door. In other words, the door extends in a plane substantially parallel to the plane of the wall in which the frame is located. Plates 40 and 46 extend substantially parallel to one another and are sandwiched between the edge of the frame and the edge of the door. While the door is closed, adjustment mechanism 36 facilitates movement of the door leaf 34 relative to the frame leaf 32 in a substantially horizontal direction, facilitating more accurate and simplified adjustment and repositioning of the door with respect to the frame. Although adjustment mechanism is illustrated as adjusting or repositioning door leaf 34 relative to frame leaf 32, in other embodiments, adjustment mechanism 36 may alternatively adjust frame leaf relative to door leaf. In other embodiments, the entire hinge design may be reversed. For example, the sleeves could be on the door leaf and the frame leaf could have a stem

As shown in FIG. 4, in the example illustrated, adjustment mechanism 36 is substantially, if not entirely, contained within sleeves 42 and the cylindrical volume contained or formed between sleeves 42 (that portion contained by cover 52). As a result, adjustment mechanism 36 may be actuated to reposition door leaf 34 while the door is closed and without having to provide special modifications to either the frame or the door to accommodate adjustment mechanism 36. At the same time, adjustment mechanism 36 remains largely concealed, being aesthetically attractive and appearing as a standard non-adjustable hinge.

In the example illustrated, adjustment mechanism 36 repositions or relocates door leaf 34 relative to frame leaf 32 and relative to the attached frame by being rotated about axis 44 in either the directions as indicated by arrows 58 in FIG. 4. In the example illustrated, adjustment mechanism 36 is accessible and actuatable via an axis opening 60 formed in the lower most sleeve 42. In the example illustrated, adjustment mechanism 36 is actuated using a hex key. In other embodiments, adjustment mechanism 36 may be actuated using other tools and via access openings at other locations or at other orientations. For example, in other embodiments, adjustment mechanism 36 may alternatively be located so as to be actuated via an access opening proximate the uppermost sleeve 42.

FIGS. 5-7 illustrates adjustment mechanism 36 in more detail. In the example illustrated, adjustment mechanism 36 includes cam 62, guides 64 and retainer mechanism 65. Cam 62 includes base or lower cam portion 66, camshaft 68 and top or upper cam portion 70 (shown in FIG. 5). Cam portions 66 and 70 comprised structures configured to rotate about axis 44. In the example illustrated, cam portions 66 and 70 are rotationally fit within and guided by sleeves 42. Camshaft 68 extends between cam portion 66 and 70 eccentric to axis 44 and engaging stem 48. In the example illustrated, shaft 68 extends through channel 54 such that during rotation of cam 62, shaft 68 moves in an arc moving stem 48 (serving as a cam follower) and door plate 46. Although camshaft 68 is illustrated as completely extending through channel 54, in other embodiments, shaft 68 may be coupled to stem 48 in other fashions. For example, in another embodiment, shaft 68 may extend only partially into stem 48 or may be fixedly secured to stem 48.

Guides 64 comprise structures that are rotationally supported for rotation about axis 44. Guides 64 are configured to guide or control movement of stem 48 as cam 62 is being rotated. In the example illustrated, guides 64 control the movement of stem 48 such that stem 48 translates or moves linearly. This also results in linear movement of door plate 46. As a result, the door attached to door plate 46 is less likely to move in an out of a frame (in a direction perpendicular to the opening of a frame) during such horizontal adjustment of hinge 30. In the example illustrated, each guide 64 includes a slot 74 extending substantially perpendicular to axis 44 and substantially parallel to the direction indicated by arrows 56 in FIG. 2. In other embodiments, guides 74 may have other configurations or may be omitted. For example, in embodiments where guides 74 have other configurations or are omitted, rotation of cam 62 may result in movement of stem 48 and door plate 46 in an arc.

In the example illustrated, each guide 74 includes a pair of tabs or fingers 76 which form the slot 74 therebetween. In one embodiment, such fingers 76 are resiliently flexible such that fingers 76 may be snapped into place onto opposite sides or ends of stem 48 during assembly. In one embodiment, guides 74 are dimensioned and are formed from one or more polymeric materials so as to be resiliently flexible. In other embodiments, guides 74 may be formed from other materials and may have other configurations.

Retainer mechanism 65 comprises a mechanism configured to retain the positioning of cam 62 and door leaf 34 once manually set. Retainer mechanism 65 is actuatable between a released state in which door leaf 34 is movable in the substantially horizontal direction and a secured state in which door leaf 34 is retained against movement in the substantially horizontal direction. For purposes of the disclosure, the term horizontal or horizontal direction of movement refers to the direction when hinge 30 is attached to a door and a frame such that the door rotates about a substantially vertical axis. In other embodiments which hinge 30 is utilized to support a door for pivotal movement about a substantially horizontal axis, such adjustment would occur in a vertical direction.

According to one embodiment, retainer mechanism 65 actuates between the released state and the secured state in response to an applied linear force in a direction substantially parallel to or contiguous with axis 44. In one embodiment, the linear force is applied through an axis opening facing in a direction parallel to axis 44. In the example illustrated, such linear force is applied via access opening 60 (shown in FIG. 4). In other embodiments, retainer mechanism 65 may be actuated between the released state and the secured state in response to torque or rotational force, in response to applied force in other directions or through other access openings or ports.

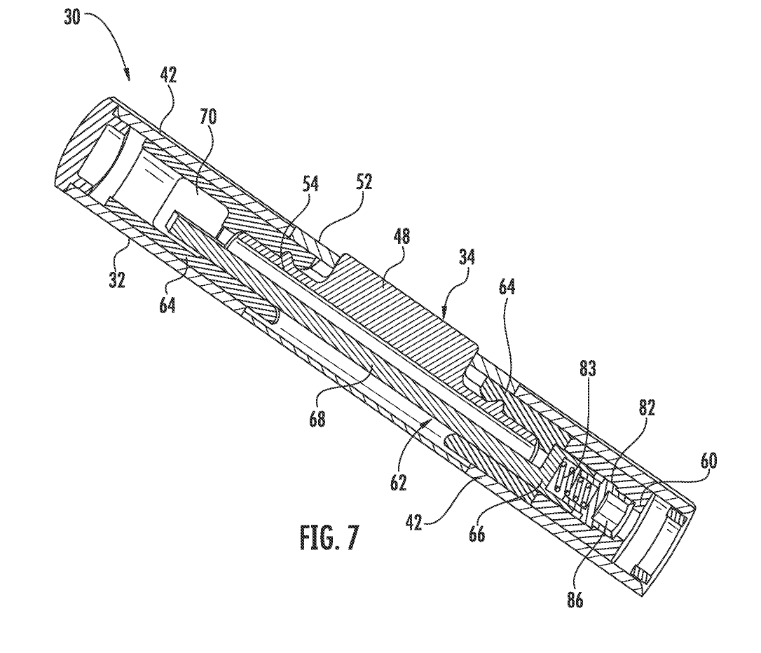

In the particular example illustrated, retainer mechanism 65 comprises outer spline 80, inner spline 82 and bias 83 (shown in FIG. 7). Outer spline 80 comprises a member that is rotationally guided and fits within one of sleeves 42. Spline 80 forms access opening 60 and includes teeth 84. In the example illustrated, outer spline 80 is configured to snap onto one of guides 64.

Inner spline 82 comprises a member having a lower rotational tool engaging structure 86 (shown in FIG. 4), a cam connecting portion 88 and teeth 90. Structure 86 comprises a structure configured to be engaged by a rotational tool. In the example illustrated, structure 86 comprises a polygonal detent configured to receive a corresponding polygonal tool (shown as a hex opening configured to receive a hex key). In other embodiments, structure 86 may comprise a Philips screw head structure, a flathead structure, a star receiving structure or other structures. In some embodiments, a wing nut or similar rotational lever may be releasably attached to inner spline 82 through access opening 60 or may be permanently fastened to or formed as part of inner spline 82 and extending through access opening 60.

Cam connecting portion 88 connects inner spline 82 to cam 62. In the example illustrated, inner spline 82 includes a polygonal projection which is received within a corresponding polygonal opening in lower cam portion 66. This arrangement allows the inner spline and the cam to move linearly relative to each other but not rotationally. In other embodiments, inner spline 82 may be connected to, fastened to, bonded to, welded to or integrally formed as part of cam 62.

Teeth 90 extend along the outer surface of inner spline 82 and a configured to engage and interleave between teeth 84 of outer spline 80 when inner spline 82 is engaged with outer spline 80 to inhibit rotation of inner spline 82 and cam 62. In other embodiments, teeth may alternatively be provided on axial ends of splines 80, 82. In other embodiments, the teeth of outer spline 80 may face outwardly, wherein inner spline may have inwardly facing teeth.

Bias 83 (shown in FIG. 7) resiliently biases or urges inner spline 82 into engagement with outer spline 80. In the example illustrated, bias 83 comprises a compression spring captured between inner spline 82 and cam 62. Compression of bias 83 allows inner spline 82 to axially move along axis 44 such that teeth 90 disengage or are withdrawn from teeth 84 such that inner spline 82 and cam 62 may be rotated to reposition door leaf 46. In other embodiments, inner spline 82 and outer spline 80 may be resiliently biased into engagement with one another in other fashions. In yet other embodiments, retainer mechanism 65 may utilize friction in place of teeth to inhibit rotation of inner spline 82 and/or cam 62.

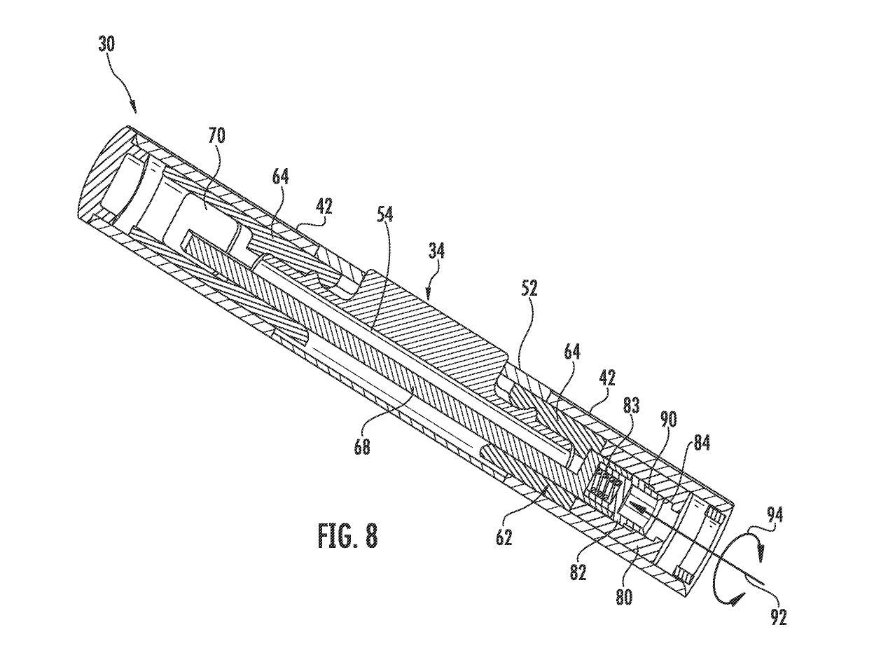

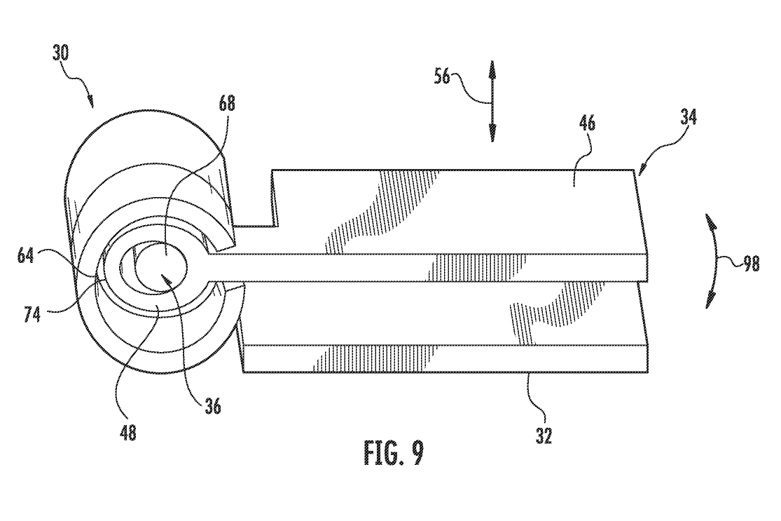

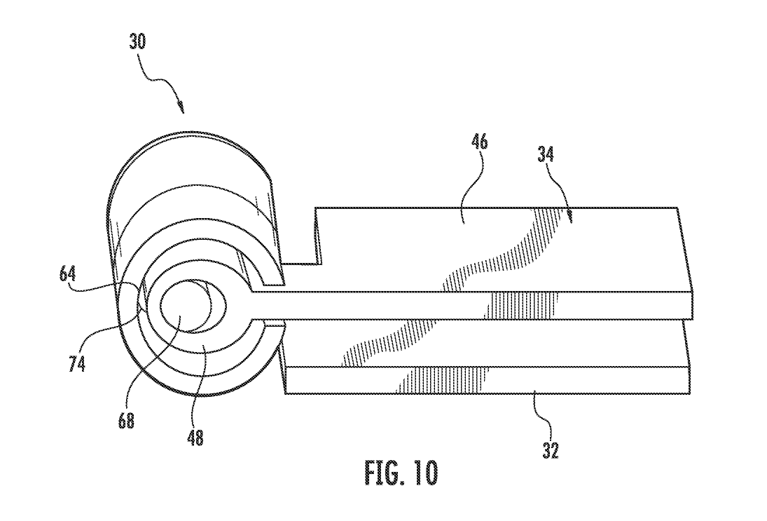

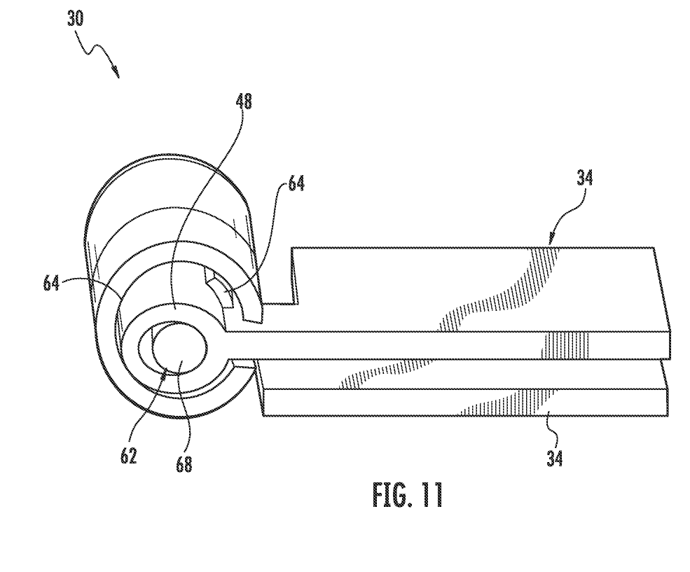

FIGS. 7-11 illustrate operation of adjustment mechanism 36. As shown FIG. 7, a tool, such as a hex key, is inserted through access opening 60 and brought into engagement or contact with inner spline 82. As shown in FIG. 8, linear force in the direction indicated by arrow 90 is applied so as to compress bias 83 and disengage teeth 90 from teeth 84, allowing rotation of inner spline 82. As indicated by arrows 94, inner spline 82 is rotated while disengaged from outer spline 80 so as to rotate cam 62. As shown in FIGS. 9-11, such rotation results in stem 48 linearly moving within the slot 74 formed by fingers 76 of guides 64. This results in movement of door leaf 34 and door plate 46 in the direction 56 (the substantially horizontal direction when hinge 30 is rotated 90 degrees as when supporting a door in a frame). As noted above, in other embodiments, guides 64 providing slots 74 may be omitted. This would alternatively result in door plate 46 moving in an arc as indicated by arrows 98 in FIG. 9.

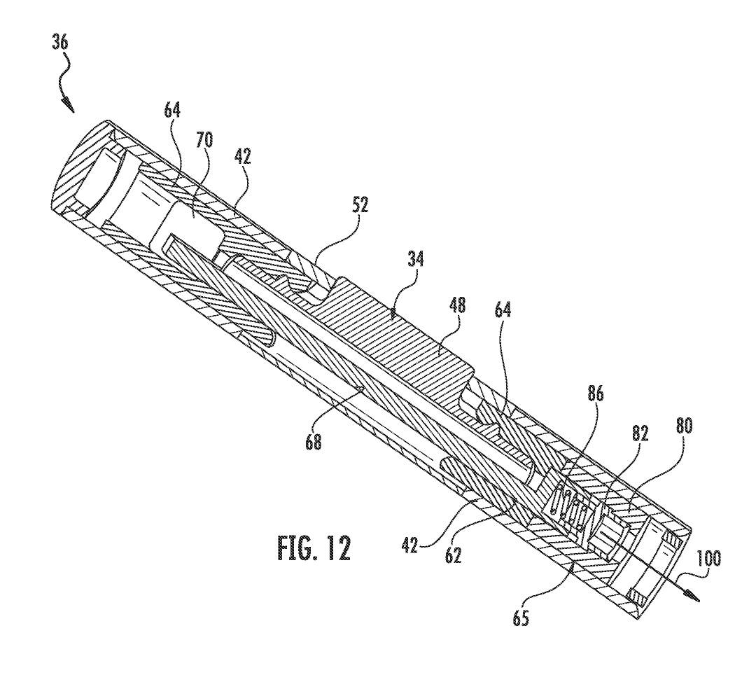

As shown by FIG. 12, when the tool (hex key) is removed as indicated by arrow 100, bias 83 resiliently returns to its original state and moves or returns inner spline 82 back into engagement with outer spline 80. As a result, retainer mechanism 65 is once again in the secured or locked position, inhibiting rotation of cam 62 and movement of door leaf 34 in the substantially horizontal direction.

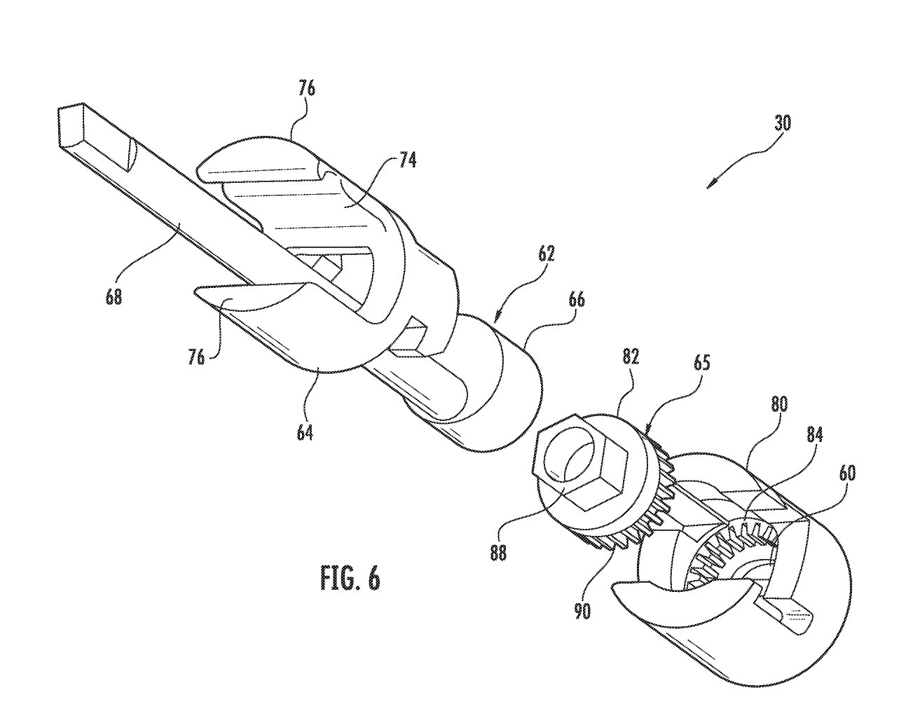

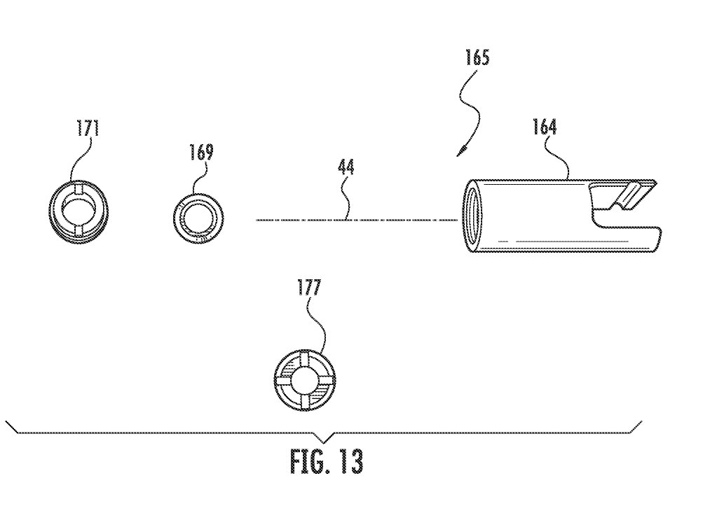

FIG. 13 illustrates retainer mechanism 165, another embodiment of retainer mechanism 65. As shown by FIG. 13, retainer mechanism 165 includes tabs 167, expansion member 169 and threaded rotatable member 171. Tabs 167 extend from cam portion 66 of cam 62. Note that cam portion 66 includes an opening 69 facilitating connection of portion 66 to cam shaft 68 (shown in FIG. 6). Tabs 167 include externally threaded portions 173 configured to threadably engage in an internally threaded bore 175 within guide 164. Tabs 167 are expandable in a radial direction and are resilient in nature. As shown by FIG. 18, tabs include tool engaging structures 177 facilitating rotation of tabs 167 and cam 62.

Expansion member 169 comprises a frustro-conical shaped member movable along axis 44 to a first position in which expansion member 169 extends between tabs 167 to outwardly expand or press the tabs towards the sleeve or guide 164 such that tabs 167 and cam 62 may no longer be rotated and such that retainer mechanism 165 is in the secured state. In a second position, expansion member 169 is withdrawn or at least partially withdrawn from tabs 167, allowing tabs 167 to resiliently move radially inward such that tabs 167 and cam 62 may be rotated (the released state).

Threaded rotatable member 171 is threadably received within bore 175 and includes a tool engaging structure 181 configured to receive a rotational tool such as a flathead screwdriver. Rotation of member 171 moves expansion member 169 along axis 44 between the first position and the second position. When assembled, rotation of tabs 167 within the threaded bore 175 of guide 164 results and repositioning of door plate 34 (shown in FIG. 1). Once the desired position has been established, member 181 is rotated to move expansion member 169 so as to lock tabs 167 frictionally against guide 164. As a result, the desired position of door leaf 34 is locked in place.

In another embodiment, retainer mechanism 165 omits tabs 167, members 169 and 171. In such an embodiment, cam portion 66 is threaded and is prevented from rotating by a friction member such as loctite or a nylon lock friction patch. This embodiment relies on the torque required to adjust the hinge being much smaller than the torque required to adjust it. By putting a nylon patch (such as those commercially available from Nylok of 15260 Hallmark Court, Macomb, Mich. 48042-4007 on the threaded cam member 66, it increases the torque necessary to turn the member so that it won't move on its own but can be moved by user with a tool.

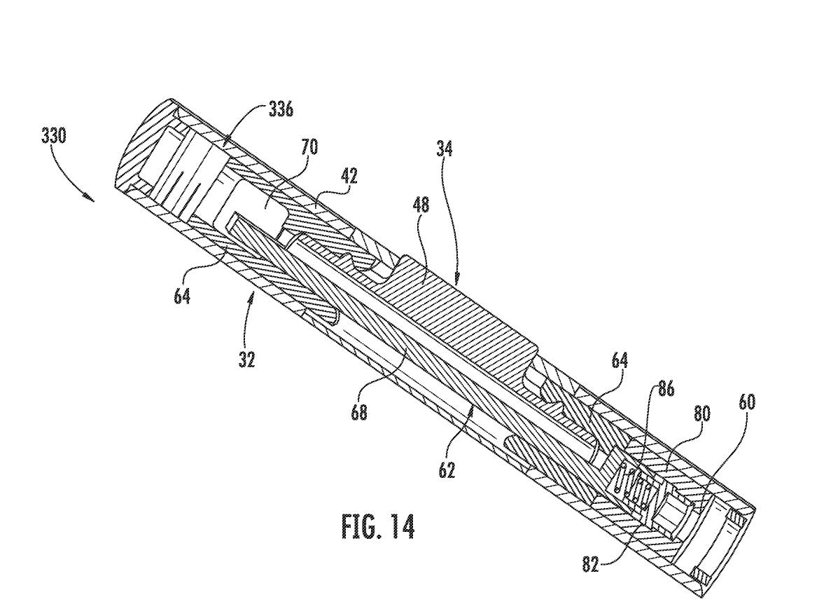

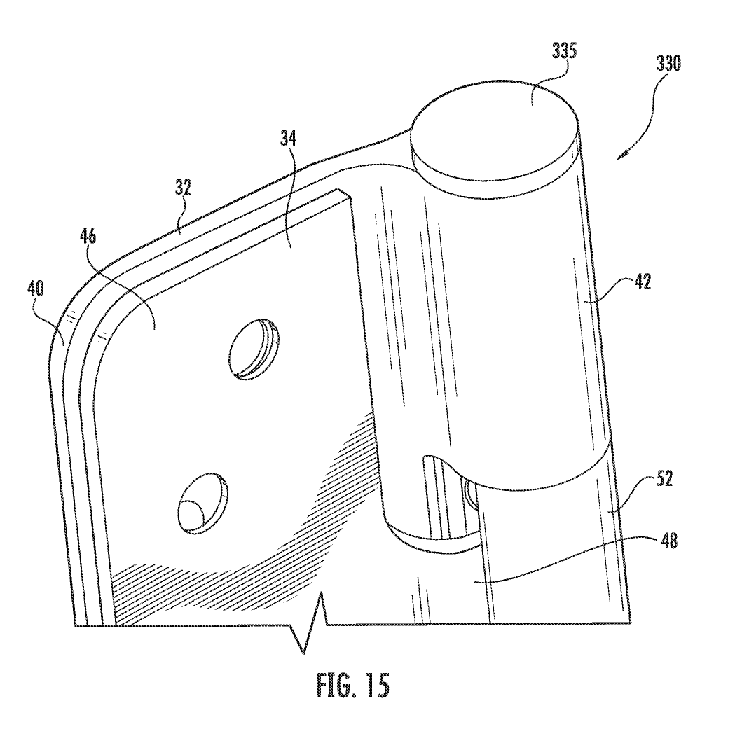

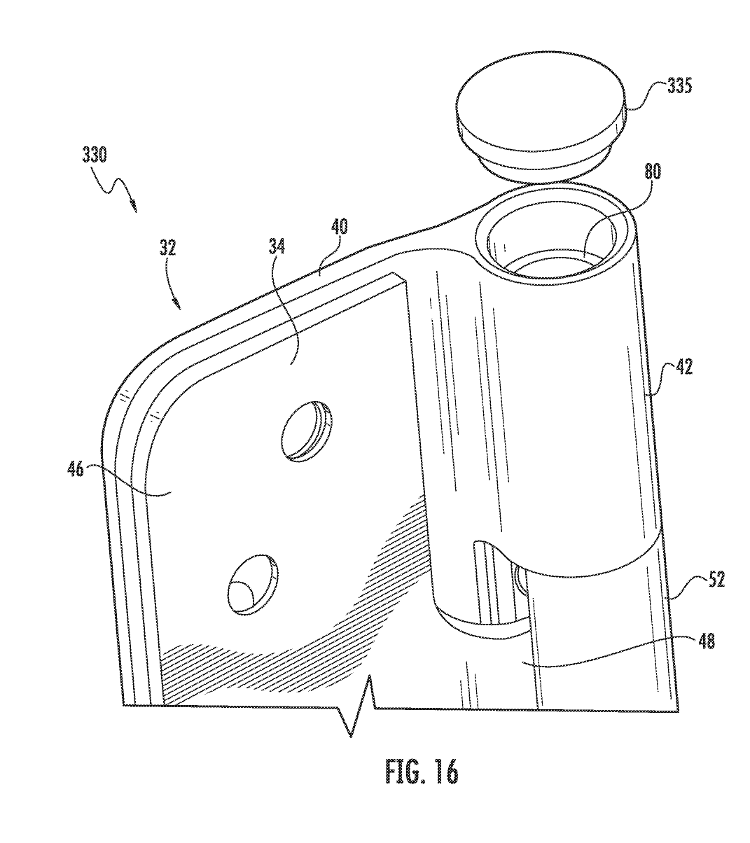

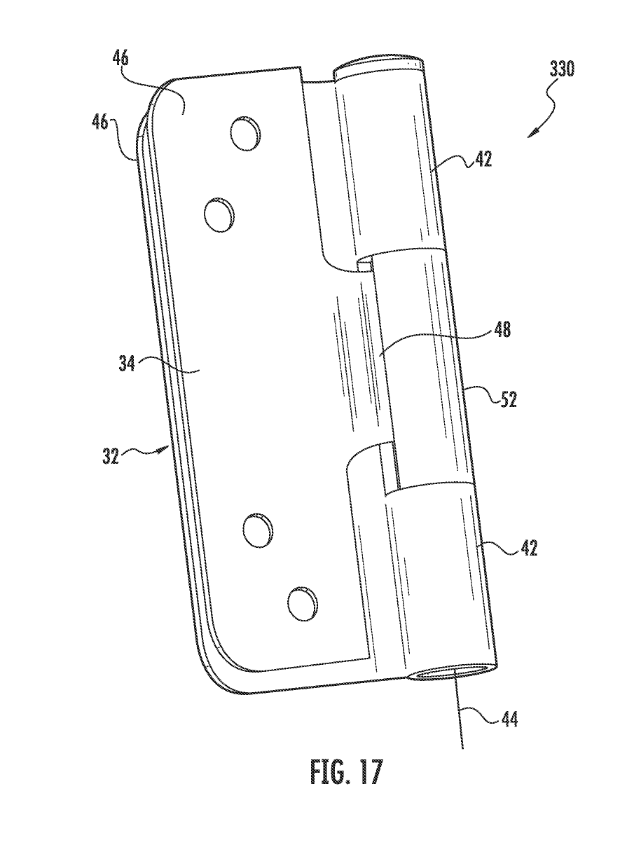

FIGS. 14-17 illustrate hinge 330, another embodiment of hinge 30. Hinge 330 is similar to hinge 30 except that hinge 330 additionally includes a vertical adjustment mechanism 336. The remaining components of hinge 330 which correspond to components of hinge 30 are numbered similarly. As noted in the figures, in such an embodiment, vertical adjustment mechanism 336 is located at a bottom (the lower sleeve 42) of hinge 330 while adjustment mechanism 36 is located at a top of hinge 330 and is covered with a cap 335 as shown in FIG. 23. In other embodiments, this relationship may be reversed. Vertical adjustment mechanism 336 (a set screw) allows door leaf 34 to be vertically adjusted in a direction substantially parallel to axis 44 as shown in FIG. 17.

Although the present disclosure has been described with reference to example embodiments, workers skilled in the art will recognize that changes may be made in form and detail without departing from the spirit and scope of the defined subject matter. For example, although different example embodiments may have been described as including one or more features providing one or more benefits, it is contemplated that the described features may be interchanged with one another or alternatively be combined with one another in the described example embodiments or in other alternative embodiments. Although the hinges have been described using the terms door and frame, each of the hinges may be used to pivot any first structure or member relative to another structure or member. Because the technology of the present disclosure is relatively complex, not all changes in the technology are foreseeable. The present disclosure described with reference to the example embodiments and set forth in the following claims is manifestly intended to be as broad as possible. For example, unless specifically otherwise noted, the claims reciting a single particular element also encompass a plurality of such particular elements.

What is claimed is:

1. A hinge comprising:
a first leaf comprising:
a first plate; and
at least one sleeve coupled to the first plate and centered along an axis;
a second leaf having a second plate; and
an adjustment mechanism configured to move and retain one of the first leaf and the second leaf relative to the other of the first leaf and the second leaf at a plurality of positions in a first direction substantially perpendicular to the axis while the second plate extends substantially parallel to the first plate and while the first plate and the second plate are mounted to structures being pivoted by the hinge.

2. The hinge of claim 1, wherein the adjustment mechanism is entirely contained within a volume defined by the at least one sleeve and any space between more than one sleeve.

3. The hinge of claim 1, wherein the adjustment mechanism is actuatable to adjust the second leaf relative to the first leaf in the first direction via an access opening facing in a second direction substantially parallel to the axis.

4. The hinge of claim 1, wherein the adjustment mechanism comprises a cam rotatable about the axis and eccentrically coupled to the second leaf.

5. The hinge of claim 4, wherein the second leaf includes a stem having an opening and wherein the cam comprises a cam shaft received within the opening.

6. The hinge of claim 5, wherein the opening has a non-circular cross-section.

7. The hinge of claim 1 further comprising at least one guide configured to direct linear movement of the second leaf in the first direction.

8. The hinge of claim 7, wherein the guide is rotatable within the at least one sleeve.

9. The hinge of claim 1, wherein the adjustment mechanism includes a retainer mechanism that is actuatable between a released state in which the second leaf is movable in the first direction and a secured state in which the second leaf is retained against movement in the first direction.

10. The hinge of claim 9, wherein the retainer mechanism actuates between the released state and the secured state in response to applied linear force in a second direction substantially parallel or contiguous with the axis.

11. The hinge of claim 10, wherein the hinge includes an access opening through which the force is applied to actuate the retainer mechanism from the secured state to the released state and through which torque or rotation is applied to move the second leaf relative to the first leaf in the first direction.

12. The hinge of claim 1, wherein the adjustment mechanism comprises a cam rotatable about the axis and eccentrically coupled to the second leaf and a retainer mechanism that is actuatable between a released state in which the second leaf is movable in the first direction and a secured state in which the second leaf is retained against movement in the first direction, the retainer mechanism comprising:
a first spline rotatable within the at least one sleeve;
a second spline coupled to the cam; and
a bias resiliently biasing the first and the second spline into engagement and the retainer mechanism into the secured state, wherein the applied force moves at least one of the first spline and the second spline out of engagement and into the released state.

13. The hinge of claim 12, wherein the bias comprises a compression spring captured between the cam and the first spline.

14. The hinge of claim 1 further comprising a retainer mechanism that is actuatable between a released state in which the second leaf is movable in the first direction and a secured state in which the second leaf is retained against movement in the first direction, wherein the retainer mechanism is configured to be rotated between the released state and the secured state.

15. The hinge of claim 14, wherein the adjustment mechanism comprises a cam rotatable about the axis and eccentrically coupled to the second leaf and wherein the retainer mechanism comprises:
a plurality of resilient tabs coupled to an extending from the cam within the at least one sleeve;
an expansion member movable along the axis between a first position in which the expansion member extends between a plurality of tabs to outwardly press the plurality of tabs towards the sleeve in which the retainer mechanism is in the secured state and a second position at least partially withdrawn from between the plurality of tabs in which the retainer mechanism is in a released state; and
a threaded rotatable member within the sleeve, wherein rotation of the threaded rotatable member moves the expansion member along the axis between the first position and the second position.

16. The hinge of claim 14, wherein the adjustment mechanism comprises a cam rotatable about the axis and eccentrically coupled to the second leaf and wherein the retainer mechanism comprises:
threads on the cam; and
a friction member on the threads.

17. The hinge of claim 1, wherein the adjustment mechanism linearly moves the second leaf relative to the first leaf.

18. The hinge of claim 1, wherein the adjustment mechanism arcuately moves the second leaf relative to the first leaf.

19. The hinge of claim 1, wherein the first leaf includes a lowermost sleeve and wherein the adjustment mechanism is actuatable to adjust the second leaf relative to the first leaf in the first direction via an access opening in the lowermost sleeve.

20. The hinge of claim 1 further comprising a second adjustment mechanism configured to move and retain the second leaf relative to the first leaf at a plurality of positions substantially parallel to the axis while the leaf plate is connected to a closed door.

21. The hinge of claim 1, wherein the at least one sleeve includes first and second spaced sleeves having a diameter, wherein the adjustment mechanism is entirely contained within a volume defined by the first and second sleeves and a cylindrical space between the first and second sleeves and having the diameter.
